(19) United States
(12) Patent Application Publication
(10) Pub. No.: US 2024/0273382 A1
(43) Pub. Date: Aug. 15, 2024

(54) SYSTEM, METHOD, AND COMPUTER PROGRAM FOR COMPUTING DATA CONTRACTION AND SIMILARITY FROM HETEROGENEOUS DATA DESCRIPTORS

(71) Applicant: JPMorgan Chase Bank, N.A., New York, NY (US)

(72) Inventors: Leonidas TSEPENEKAS, College Park, MD (US); Ivan BRUGERE, Palo Alto, CA (US); Freddy LECUE, Mamaroneck, NY (US); Daniele MAGAZZENI, London (GB)

(73) Assignee: JPMorgan Chase Bank, N.A., New York, NY (US)

(21) Appl. No.: 18/112,341

(22) Filed: Feb. 21, 2023

(30) Foreign Application Priority Data
Feb. 14, 2023 (GR) 20230100127

(51) Int. Cl. G06N 5/022; G06N 5/01

(52) U.S. Cl. CPC G06N 5/022; G06N 5/01

(57) ABSTRACT

Various methods, apparatuses/systems, and media for computing data contraction and similarity from heterogeneous data descriptors are disclosed. A processor computes common features data among a first data point and a second data point by comparing the first data point and the second data point and their respective data distributions; links a pre-computed knowledge graph with the first data point and the second data point; computes, in response to linking, knowledge-comparable features data among the first data point and the second data point based on other features, received as input, that are not common features; computes knowledge-comparable data based on the knowledge-comparable features data and the common features data; computes similarity of the first data point and the second data point based on the knowledge-comparable data; and generates a data contraction map along with assigned similarity score based on the computed similarity.

### CROSS-REFERENCE TO RELATED APPLICATIONS

This application claims the benefit of priority from Greek Patent Application No. 20230100127, filed Feb. 14, 2023, which is herein incorporated by reference in its entirety.

### TECHNICAL FIELD

This disclosure generally relates to data processing, and, more particularly, to methods and apparatuses for implementing a data contraction and similarity computing module configured to compute data contraction and estimate similarity of data distribution from heterogeneous data descriptors.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Today, a wide variety of business functions are commonly supported by software applications and tools, i.e., business intelligence (BI) tools. For instance, software has been directed to data processing, data migration, monitoring, performance analysis, project tracking, data management, generating bond pricing, predicting stock pricing, and competitive analysis, to name but a few. Accurate and meaningful risk analysis may prove to be essential to superior investment performance, i.e., generating bond pricing, predicting stock pricing, etc. Often, prediction models are utilized to minimize such risks. Moreover, relations between input data points of a prediction model and explanations may prove to be very complex due to the complexity of underlying machine learning models e.g., non-linearity in Deep Neural Network architectures.

For example, today, machine learning models are being utilized more frequently in data processing. However, it may require good labels attached to each data points, e.g., a car application may be labelled as approved or rejected after a decision making process. Typically, where data is not qualitatively labelled, one may need to rely heavily on unsupervised machine learning techniques to build models an industry could operate on. In such settings, the core requirements may prove to be a similarity metric to compare and rank input data points. However, such a similarity metric may not necessarily exist, especially because data to be compared may be coming from different distributions, or poorly described along different representations and features.

Thus, the conventional tools fail to compare data points coming from different distributions, with little (or even no) shared characteristics. For example, it may prove to be extremely difficult to compare two individuals where one individual is described by their age, family situation, city address and the other individual is described by its state location. This may prove to be complicated, for example, in a loan approval process where comparing and ranking loan applications are necessary to approve or deny an application. Especially when external data is collected to enrich an application, but when not all applications share the same characteristics. This may be especially true for new applicants where external data is collected in an inconsistent way, i.e., applications do not share all the same descriptions or features.

Thus, there is a need for an advanced tool that can compute data contraction and estimate similarity of data distribution from heterogeneous data descriptors.

### SUMMARY

The present disclosure, through one or more of its various aspects, embodiments, and/or specific features or sub-components, provides, among other features, various systems, servers, devices, methods, media, programs, and platforms for implementing a data contraction and similarity computing module configured to compute data contraction and estimate similarity of data distribution from heterogeneous data descriptors, i.e., from different data distribution, or with different predictors or features or characteristics, but the disclosure is not limited thereto. For example, the present disclosure, through one or more of its various aspects, embodiments, and/or specific features or sub-components, provides, among other features, various systems, servers, devices, methods, media, programs, and platforms for implementing a data contraction and similarity computing module configured to compute data contraction, and utilize the contraction as a way to evaluate data comparison and ranking, and thereby generating explanatory elements for data mapping and similarity comparison for heterogeneous data sets, but the disclosure is not limited thereto.

According to exemplary embodiments, a method for computing data contraction and estimating similarity of data points from heterogeneous data descriptors by utilizing one or more processors along with allocated memory is disclosed. The method may include: receiving a first input raw dataset and a second input raw dataset that are usable for computing common features data: generating a first data point from the first input raw dataset and generating a second data point from the second input raw dataset: computing common features data among first data point and the second data point by comparing the first data point and the second data point and their respective data distributions: linking a pre-computed knowledge graph with the first data point and the second data point: computing, in response to linking, knowledge-comparable features data among the first data point and the second data point based on other features, received as input, that are not common features: computing knowledge-comparable data based on the knowledge-comparable features data and the common features data: computing similarity of the first data point and the second data point based on the knowledge-comparable data; and generating a data contraction map along with assigned similarity score based on the computed similarity.

According to exemplary embodiments, the method may further include: applying a data distribution sampling algorithm onto each of said first input raw dataset and said second input raw dataset to generate a first sampled dataset and a second sampled dataset, respectively.

According to exemplary embodiments, wherein a size of the first sampled dataset may be smaller than the first received input raw dataset, and wherein a size of the second sampled dataset may be smaller than the second received input raw dataset.

According to exemplary embodiments, in computing the common features, the method may further include: receiving as input data the following data: the first data point generated from the first input raw dataset, the second data point generated from the second input raw dataset, the first sampled data set, and the second sampled dataset: retrieving exact same features among the first data point and the second data point; and retrieving exact same features among the first sampled data set and the second sampled dataset.

According to exemplary embodiments, in computing knowledge-comparable data, the method may further include: implementing a corresponding transforming algorithm to transform corresponding received input data with respect to the common features and knowledge-comparable features sets.

According to exemplary embodiments, wherein the precomputed knowledge graph is a tree-like data structure that captures domain knowledge corresponding to a line of business.

According to exemplary embodiments, wherein the line of business includes applications for loan approval.

According to exemplary embodiments, in computing the similarity of the first data point and the second data point, the method may further include: applying an independent and identically distributed sampling algorithm to each of said first input raw dataset and said second input raw dataset to construct seed points: implementing an intra-dataset mapping algorithm that maps an expanded set to a seed point among the constructed seed points using a radius of an accuracy factor, wherein the accuracy factor is a parameter controlling an approximation error of a distance mapping value in an interval (0,1); implementing an inter-dataset mapping algorithm that selects, for every pair of input raw datasets, a unique pair of seeds in the distance mapping; and querying, in response to selecting, a distance between the first data point and the second data point.

According to exemplary embodiments, a system for computing data contraction and estimating similarity of data points from heterogeneous data descriptors is disclosed. The system may include: a processor; and a memory operatively connected to the processor via a communication interface, the memory storing computer readable instructions, when executed, may cause the processor to: receive a first input raw dataset and a second input raw dataset that are usable for computing common features data: generate a first data point from the first input raw dataset and generate a second data point from the second input raw dataset: compute common features data among first data point and the second data point by comparing the first data point and the second data point and their respective data distributions: link a pre-computed knowledge graph with the first data point and the second data point: compute, in response to linking, knowledge-comparable features data among the first data point and the second data point based on other features, received as input, that are not common features: compute knowledge-comparable data based on the knowledge-comparable features data and the common features data: compute similarity of the first data point and the second data point based on the knowledge-comparable data; and generate a data contraction map along with assigned similarity score based on the computed similarity.

According to exemplary embodiments, the processor may be further configured to: apply a data distribution sampling algorithm onto each of said first input raw dataset and said second input raw dataset to generate a first sampled dataset and a second sampled dataset, respectively.

According to exemplary embodiments, in computing the common features, the processor may be further configured to: receive as input data the following data: the first data point generated from the first input raw dataset, the second data point generated from the second input raw dataset, the first sampled data set, and the second sampled dataset: retrieve exact same features among the first data point and the second data point; and retrieve exact same features among the first sampled data set and the second sampled dataset.

According to exemplary embodiments, in computing knowledge-comparable data, the processor may be further configured to: implement a corresponding transforming algorithm to transform corresponding received input data with respect to the common features and knowledge-comparable features sets.

According to exemplary embodiments, in computing the similarity of the first data point and the second data point, the processor may be further configured to: apply an independent and identically distributed sampling algorithm to each of said first input raw dataset and said second input raw dataset to construct seed points: implement an intra-dataset mapping algorithm that maps an expanded set to a seed point among the constructed seed points using a radius of an accuracy factor, wherein the accuracy factor is a parameter controlling an approximation error of a distance mapping value in an interval (0,1); implement an inter-dataset mapping algorithm that selects, for every pair of input raw datasets, a unique pair of seeds in the distance mapping; and query, in response to selecting, a distance between the first data point and the second data point.

According to exemplary embodiments, a non-transitory computer readable medium configured to store instructions for computing data contraction and estimating similarity of data points from heterogeneous data descriptors is disclosed. The instructions, when executed, may cause a processor to perform the following: receiving a first input raw dataset and a second input raw dataset that are usable for computing common features data; generating a first data point from the first input raw dataset and generating a second data point from the second input raw dataset: computing common features data among first data point and the second data point by comparing the first data point and the second data point and their respective data distributions: linking a pre-computed knowledge graph with the first data point and the second data point: computing, in response to linking, knowledge-comparable features data among the first data point and the second data point based on other features, received as input, that are not common features: computing knowledge-comparable data based on the knowledge-comparable features data and the common features data: computing similarity of the first data point and the second data point based on the knowledge-comparable data; and generating a data contraction map along with assigned similarity score based on the computed similarity.

According to exemplary embodiments, the instructions, when executed, may cause the processor to perform the following: applying a data distribution sampling algorithm onto each of said first input raw dataset and said second input raw dataset to generate a first sampled dataset and a second sampled dataset, respectively.

According to exemplary embodiments, in computing the common features, the instructions, when executed, may cause the processor to perform the following: receiving as input data the following data: the first data point generated from the first input raw dataset, the second data point generated from the second input raw dataset, the first sampled data set, and the second sampled dataset: retrieving exact same features among the first data point and the second data point; and retrieving exact same features among the first sampled data set and the second sampled dataset.

According to exemplary embodiments, in computing knowledge-comparable data, the instructions, when executed, may cause the processor to perform the following: implementing a corresponding transforming algorithm to transform corresponding received input data with respect to the common features and knowledge-comparable features sets.

According to exemplary embodiments, in computing the similarity of the first data point and the second data point, the instructions, when executed, may cause the processor to perform the following: applying an independent and identically distributed sampling algorithm to each of said first input raw dataset and said second input raw dataset to construct seed points: implementing an intra-dataset mapping algorithm that maps an expanded set to a seed point among the constructed seed points using a radius of an accuracy factor, wherein the accuracy factor is a parameter controlling an approximation error of a distance mapping value in an interval (0,1); implementing an inter-dataset mapping algorithm that selects, for every pair of input raw datasets, a unique pair of seeds in the distance mapping; and querying, in response to selecting, a distance between the first data point and the second data point.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a data contraction and similarity computing module configured to compute data contraction and estimate similarity of data distribution from heterogeneous data descriptors in accordance with an exemplary embodiment.

FIG. 2 illustrates an exemplary diagram of a network environment with a data contraction and similarity computing device in accordance with an exemplary embodiment.

FIG. 3 illustrates a system diagram for implementing a data contraction and similarity computing device having a data contraction and similarity computing module in accordance with an exemplary embodiment.

FIG. 4 illustrates a system diagram for implementing a data contraction and similarity computing module of FIG. 3 in accordance with an exemplary embodiment.

FIG. 5 illustrates an exemplary knowledge graph as implemented by the data contraction and similarity computing module of FIG. 4 in accordance with an exemplary embodiment.

FIG. 6 illustrates an exemplary data seed constructions process as implemented by the data contraction and similarity computing module of FIG. 4 in accordance with an exemplary embodiment.

FIG. 7 illustrates an exemplary dataset alignment process as implemented by the data contraction and similarity computing module of FIG. 4 in accordance with an exemplary embodiment.

FIG. 8 illustrates an exemplary flow diagram implemented by the data contraction and similarity module of FIG. 4 for computing data contraction and estimate similarity of data distribution from heterogeneous data descriptors in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

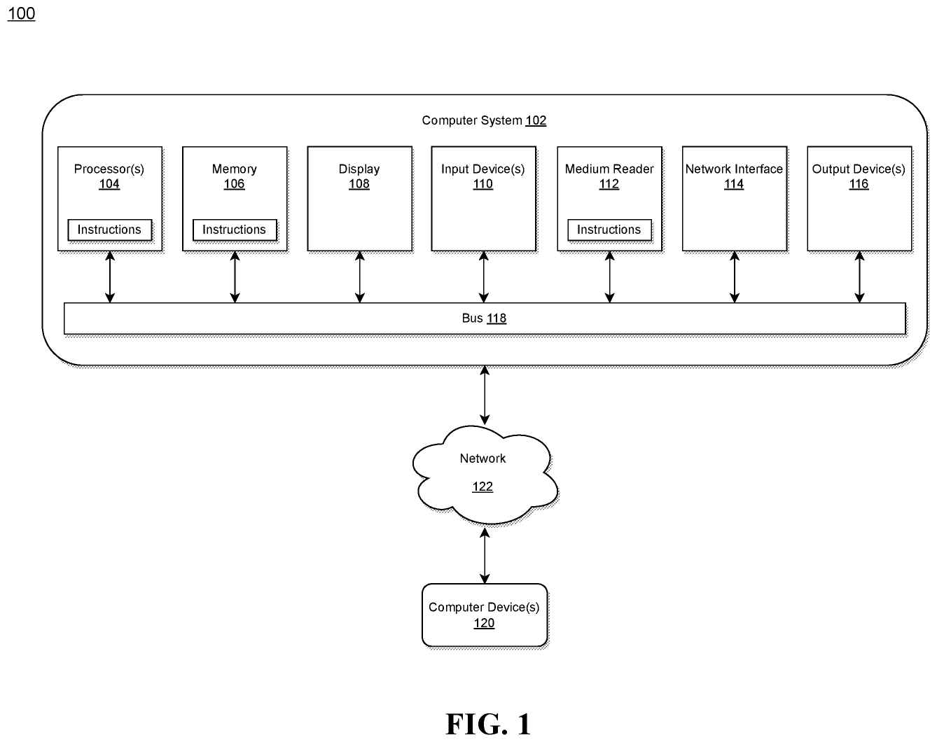

FIG. 1 is an exemplary system 100 for use in implementing a platform, language, database, and cloud agnostic data points computing module configured to compute change-agnostic data points in accordance with an exemplary embodiment. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

According to exemplary embodiments, the data contraction and similarity computing module may be platform, language, database, and cloud agnostic that may allow for consistent easy orchestration and passing of data through various components to output a desired result regardless of platform, language, database, and cloud environment. Since the disclosed process, according to exemplary embodiments, is platform, language, database, and cloud agnostic, the data contraction and similarity computing module may be independently tuned or modified for optimal performance without affecting the configuration or data files. The configuration or data files, according to exemplary embodiments, may be written using JSON, but the disclosure is not limited thereto. For example, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

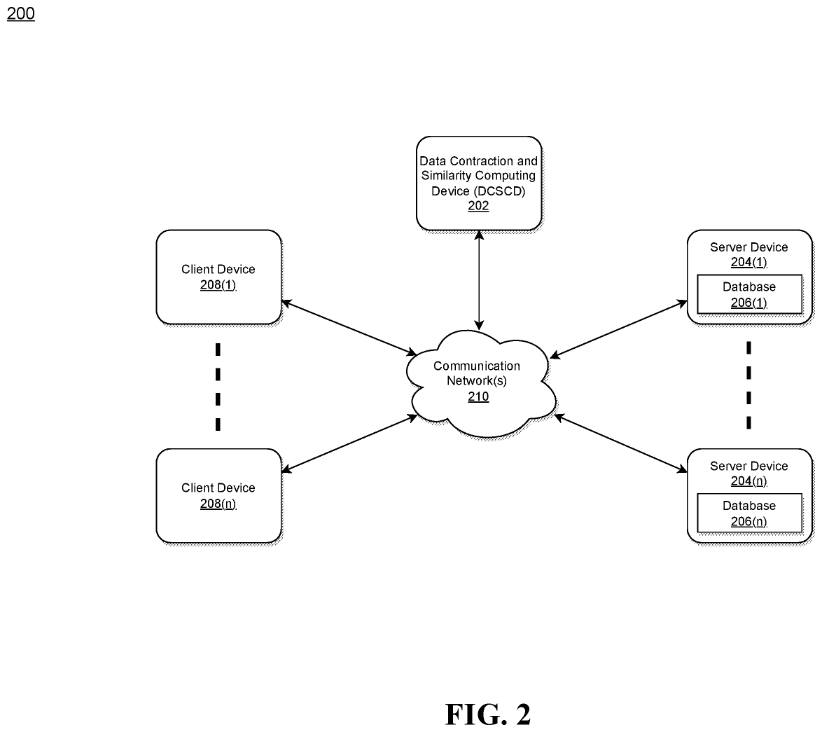

Referring to FIG. 2, a schematic of an exemplary network environment 200 for implementing a language, platform, database, and cloud agnostic data contraction and similarity computing device (DCSCD) of the instant disclosure is illustrated.

According to exemplary embodiments, the above-described problems associated with conventional tools may be overcome by implementing a DCSCD 202 as illustrated in FIG. 2 that may be configured for implementing a platform, language, cloud, and database agnostic data contraction and similarity computing module configured to compute data contraction and estimate similarity of data distribution from heterogeneous data descriptors, i.e., from different data distribution, or with different predictors or features or characteristics, but the disclosure is not limited thereto. For example, according to exemplary embodiments, the above-described problems associated with conventional tools may be overcome by implementing a DCSCD 202 as illustrated in FIG. 2 that may be configured for implementing a platform, language, cloud, and database agnostic data contraction and similarity computing module configured to compute data contraction, and utilize the contraction as a way to evaluate data comparison and ranking, and thereby generating explanatory elements for data mapping and similarity comparison for heterogeneous data sets, but the disclosure is not limited thereto.

The DCSCD 202 may be the same or similar to the computer system 102 as described with respect to FIG. 1.

The DCSCD 202 may store one or more applications that can include executable instructions that, when executed by the DCSCD 202, cause the DCSCD 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the DCSCD 202 itself, may be located in virtual server(s) running in a cloud-based computing environment rather than being tied to one or more specific physical network computing devices. Also, the application(s) may be running in one or more virtual machines (VMs) executing on the DCSCD 202. Additionally, in one or more embodiments of this technology, virtual machine(s) running on the DCSCD 202 may be managed or supervised by a hypervisor.

In the network environment 200 of FIG. 2, the DCSCD 202 is coupled to a plurality of server devices 204(1)-204(n) that hosts a plurality of databases 206(1)-206(n), and also to a plurality of client devices 208(1)-208(n) via communication network(s) 210. A communication interface of the DCSCD 202, such as the network interface 114 of the computer system 102 of FIG. 1, operatively couples and communicates between the DCSCD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the DCSCD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 202 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The DCSCD 202 may be a standalone device or integrated with one or more other devices or apparatuses, such as one or more of the server devices 204(1)-204(n), for example. In one particular example, the DCSCD 202 may be hosted by one of the server devices 204(1)-204(n), and other arrangements are also possible. Moreover, one or more of the devices of the DCSCD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the DCSCD 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the DCSCD 202 that may efficiently provide a platform for implementing a platform, language, cloud, and database agnostic data contraction and similarity computing module configured to compute data contraction and estimate similarity of data distribution from heterogeneous data descriptors, i.e., from different data distribution, or with different predictors or features or characteristics, but the disclosure is not limited thereto. According to exemplary embodiments, the client devices 208(1)-208(n) in this example may include any type of computing device that can facilitate the implementation of the DCSCD 202 that may efficiently provide a platform for implementing a platform, language, cloud, and database agnostic data contraction and similarity computing module configured to compute data contraction, and utilize the contraction as a way to evaluate data comparison and ranking, and thereby generating explanatory elements for data mapping and similarity comparison for heterogeneous data sets, but the disclosure is not limited thereto.

The client devices 208(1)-208(n) may run interface applications, such as standard web browsers or standalone client applications, which may provide an interface to communicate with the DCSCD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the DCSCD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the DCSCD 202, the server devices 204(1)-204(n), or the client devices 208(1)-208(n), for example, may be configured to operate as virtual instances on the same physical machine. For example, one or more of the DCSCD 202, the server devices 204(1)-204(n), or the client devices 208(1)-208(n) may operate on the same physical device rather than as separate devices communicating through communication network(s) 210. Additionally, there may be more or fewer DCSCDs 202, server devices 204(1)-204(n), or client devices 208(1)-208(n) than illustrated in FIG. 2. According to exemplary embodiments, the DCSCD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

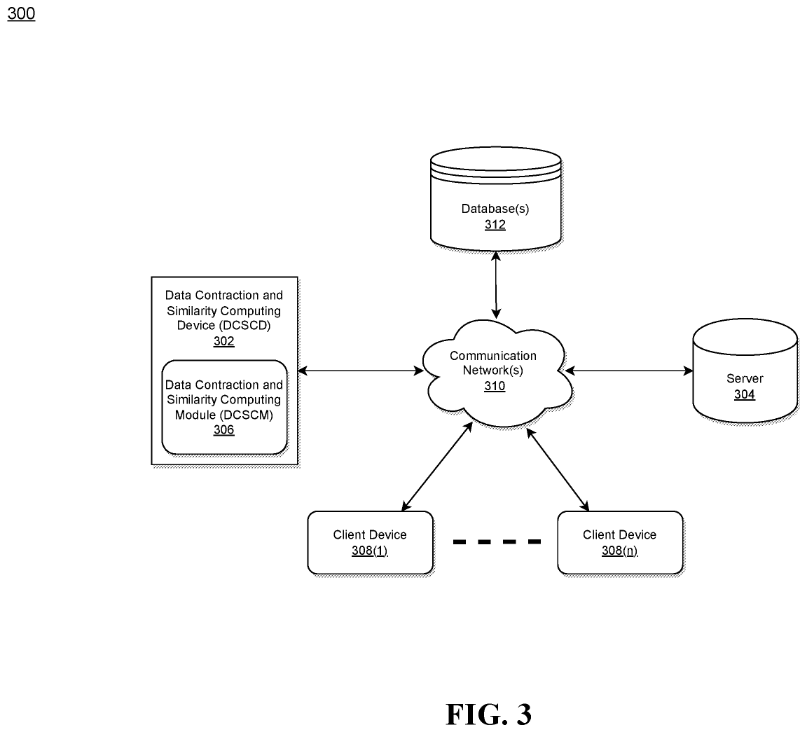

FIG. 3 illustrates a system diagram for implementing a platform, language, and cloud agnostic DCSCD having a platform, language, database, and cloud agnostic data contraction and similarity computing module (DCSCM) in accordance with an exemplary embodiment.

As illustrated in FIG. 3, the system 300 may include an DCSCD 302 within which an DCSCM 306 is embedded, a server 304, a database(s) 312, a plurality of client devices 308(1) . . . 308(n), and a communication network 310.

According to exemplary embodiments, the DCSCD 302 including the DCSCM 306 may be connected to the server 304, and the database(s) 312 via the communication network 310. The DCSCD 302 may also be connected to the plurality of client devices 308(1) . . . 308(n) via the communication network 310, but the disclosure is not limited thereto.

According to exemplary embodiment, the DCSCD 302 is described and shown in FIG. 3 as including the DCSCM 306, although it may include other rules, policies, modules, databases, or applications, for example. According to exemplary embodiments, the database(s) 312 may be configured to store ready to use modules written for each API for all environments. Although only one database is illustrated in FIG. 3, the disclosure is not limited thereto. Any number of desired databases may be utilized for use in the disclosed invention herein. The database(s) may be a mainframe database, a log database that may produce programming for searching, monitoring, and analyzing machine-generated data via a web interface, etc., but the disclosure is not limited thereto.

According to exemplary embodiments, the DCSCM 306 may be configured to receive real-time feed of data from the plurality of client devices 308(1) . . . 308(n) and secondary sources via the communication network 310.

As may be described below, the DCSCM 306 may be configured to: receive a first input raw dataset and a second input raw dataset that are usable for computing common features data: generate a first data point from the first input raw dataset and generate a second data point from the second input raw dataset: compute common features data among first data point and the second data point by comparing the first data point and the second data point and their respective data distributions: link a pre-computed knowledge graph with the first data point and the second data point: compute, in response to linking, knowledge-comparable features data among the first data point and the second data point based on other features, received as input, that are not common features: compute knowledge-comparable data based on the knowledge-comparable features data and the common features data: compute similarity of the first data point and the second data point based on the knowledge-comparable data; and generate a data contraction map along with assigned similarity score based on the computed similarity, but the disclosure is not limited thereto.

The plurality of client devices 308(1) . . . 308(n) are illustrated as being in communication with the DCSCD 302. In this regard, the plurality of client devices 308(1) . . . 308(n) may be “clients” (e.g., customers) of the DCSCD 302 and are described herein as such. Nevertheless, it is to be known and understood that the plurality of client devices 308(1) . . . 308(n) need not necessarily be “clients” of the DCSCD 302, or any entity described in association therewith herein. Any additional or alternative relationship may exist between either or both of the plurality of client devices 308(1) . . . 308(n) and the DCSCD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308(n) may communicate with the DCSCD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The DCSCD 302 may be the same or similar to the DCSCD 202 as described with respect to FIG. 2, including any features or combination of features described with respect thereto.

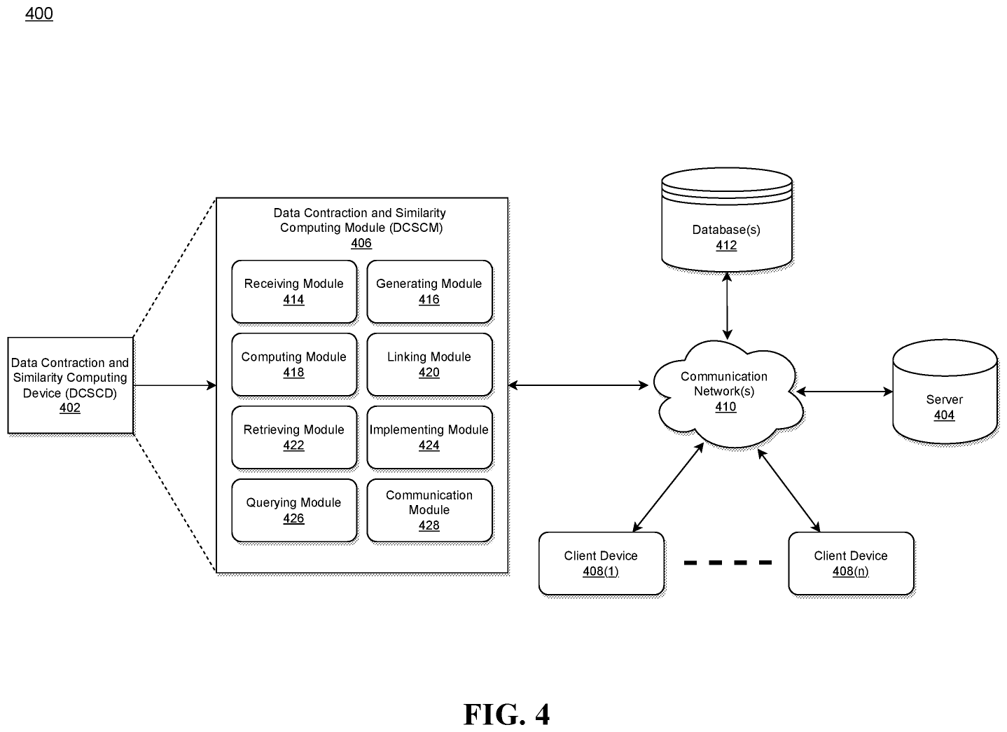

FIG. 4 illustrates a system diagram for implementing a DCSCM of FIG. 3 in accordance with an exemplary embodiment.

According to exemplary embodiments, the system 400 may include a platform, language, database, and cloud agnostic DCSCD 402 within which a platform, language, database, and cloud agnostic DCSCM 406 is embedded, a server 404, database(s) 412, and a communication network 410. According to exemplary embodiments, server 404 may comprise a plurality of servers located centrally or located in different locations, but the disclosure is not limited thereto.

According to exemplary embodiments, the DCSCD 402 including the DCSCM 406 may be connected to the server 404 and the database(s) 412 via the communication network 410. The DCSCD 402 may also be connected to the plurality of client devices 408(1)-408(n) via the communication network 410, but the disclosure is not limited thereto. The DCSCM 406, the server 404, the plurality of client devices 408(1)-408(n), the database(s) 412, the communication network 410 as illustrated in FIG. 4 may be the same or similar to the DCSCM 306, the server 304, the plurality of client devices 308(1)-308(n), the database(s) 312, the communication network 310, respectively, as illustrated in FIG. 3.

According to exemplary embodiments, as illustrated in FIG. 4, the DCSCM 406 may include a receiving module 414, a generating module 416, a computing module 418, a linking module 420, a retrieving module 422, an implementing module 424, a querying module 426, and a communication module 428. According to exemplary embodiments, interactions and data exchange among these modules included in the DCSCM 406 provide the advantageous effects of the disclosed invention. Functionalities of each module of FIG. 4 may be described in detail below with reference to FIGS. 4-6.

According to exemplary embodiments, each of the receiving module 414, the generating module 416, the computing module 418, the linking module 420, the retrieving module 422, the implementing module 424, the querying module 426, and the communication module 428 of the DCSCM 406 of FIG. 4 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

According to exemplary embodiments, each of the receiving module 414, the generating module 416, the computing module 418, the linking module 420, the retrieving module 422, the implementing module 424, the querying module 426, and the communication module 428 of the DCSCM 406 of FIG. 4 may be implemented by microprocessors or similar, and may be programmed using software (e.g., microcode) to perform various functions discussed herein and may optionally be driven by firmware and/or software.

Alternatively, according to exemplary embodiments, each of the receiving module 414, the generating module 416, the computing module 418, the linking module 420, the retrieving module 422, the implementing module 424, the querying module 426, and the communication module 428 of the DCSCM 406 of FIG. 4 may be implemented by dedicated hardware, or as a combination of dedicated hardware to perform some functions and a processor (e.g., one or more programmed microprocessors and associated circuitry) to perform other functions.

According to exemplary embodiments, each of the receiving module 414, the generating module 416, the computing module 418, the linking module 420, the retrieving module 422, the implementing module 424, the querying module 426, and the communication module 428 of the DCSCM 406 of FIG. 4 may be called via corresponding API.

According to exemplary embodiments, the process implemented by the DCSCM 406 may be executed via the communication module 428 and the communication network 410, which may comprise plural networks as described above. For example, in an exemplary embodiment, the various components of the DCSCM 406 may communicate with the server 404, and the database(s) 412 via the communication module 428 and the communication network 410. Of course, these embodiments are merely exemplary and are not limiting or exhaustive. The database(s) 412 may include the databases included within the private cloud and/or public cloud and the server 404 may include one or more servers within the private cloud and the public cloud.

Accurate and meaningful risk analysis may prove to be essential to superior investment performance, i.e., generating bond pricing, predicting stock pricing, etc. Often, prediction models are utilized to minimize such risks. Moreover, relations between input data points of a prediction model and explanations may prove to be very complex due to the complexity of underlying machine learning models e.g., non-linearity in Deep Neural Network architectures.

For example, today, machine learning models are being utilized more frequently in data processing. However, it may require good labels attached to each data points, e.g., a car application may be labelled as approved or rejected after a decision making process. Typically, where data is not qualitatively labelled, one may need to rely heavily on unsupervised machine learning techniques to build models an industry could operate on. In such settings, the core requirements may prove to be a similarity metric to compare and rank input data points. However, such a similarity metric may not necessarily exist, especially because data to be compared may be coming from different distributions, or poorly described along different representations and features. According to exemplary embodiments, the DCSCM 406 may be configured to ensure accurate computation of data contraction and estimation of similarity of data distribution from heterogeneous data descriptors, i.e., from different data distribution, or with different predictors or features or characteristics.

For example, according to exemplary embodiments, the receiving module 414 may be configured to receive a first input raw dataset and a second input raw dataset that are usable for computing common features data. The generating module 416 may be configured to generate a first data point D1 from the first input raw dataset and generate a second data point D2 from the second input raw dataset.

According to exemplary embodiments, the first input raw dataset received by the receiving module 414 may include: X1 (AGE=50, City=Houston, CarLoan=1, D=9): X2 (AGE=21, City=Dallas, CarLoan=1, D=2): X3 (AGE=40, City=LA, CarLoan=1, D=−31): . . . ; and Xn (AGE=70, City=NY, CarLoan=1, D=5). According to exemplary embodiments, the first input raw data may correspond to time series of various types of application data (i.e., car loan, mortgage loan, student loan, credit card application, etc., but the disclosure is not limited thereto) history which may be tabular data, image, or text. According to exemplary embodiments, the first data point D1 from the first input raw dataset generated by the generating module 416 may include X′2 (AGE=11, City=LA, CarLoan=1, D=2).

According to exemplary embodiments, the second input raw dataset received by the receiving module 414 may include: Y1 (AGEX=1, State=NY, HolidayLoan=0, DXXXXX=93): Y2 (AGEX=1, State=Nevada, Holiday Loan=0, DXXXXX=12); Y3 (AGEX=10, State=Texas, HolidayLoan=0, Dxxxxx=−1); . . . ; and Yn (AGEX=17, State=NY, HolidayLoan=0, Dxxxxx=15). According to exemplary embodiments, the second input raw data may also correspond to time series of various types of application data (i.e., car loan, mortgage loan, student loan, credit card application, etc., but the disclosure is not limited thereto) history which may be tabular data, image, or text. According to exemplary embodiments, the second data point D2 from the second input raw dataset generated by the generating module 416 may include Y′2 (AGEX=11, State=NY, HolidayLoan=0, Dxxxxx=2).

According to exemplary embodiments, the DCSCM 406 may be configured to apply a data distribution sampling algorithm onto each of the first input raw dataset and the second input raw dataset to generate a first sampled dataset and a second sampled dataset, respectively. According to exemplary embodiments, data distribution sampling strategies may include: strategy 1: selecting 3 random points: strategy 2: selecting 3 with feature A=0; strategy 3: selecting the first 3, etc., but the disclosure is not limited thereto.

For example, the first sampled dataset after applying the sampling algorithm onto the first input raw dataset may include: X1 (AGE=50, City=Houston, CarLoan=1, D=9); X2 (AGE=21, City=Dallas, CarLoan=1, D=2): X3 (AGE=40, City=LA, CarLoan=1, D=−31). The second sampled dataset after applying the sampling algorithm onto the second input raw dataset may include: Y1 (AGEX=1, State=NY, Holiday Loan=0, Dxxxxx=93); Y2 (AGEX=1, State=Nevada, Holiday Loan=0, DxxXXX=12); Y3 (AGEX=10, State=Texas, HolidayLoan=0, Dxxxxx=−1).

According to exemplary embodiments, the size of the first sampled dataset may be smaller than the first received input raw dataset, and the size of the second sampled dataset may be smaller than the second received input raw dataset.

According to exemplary embodiments, the computing module 418 may be configured to compute common features data among first data point D1 and the second data point D2 by comparing the first data point D1 and the second data point D2 and their respective data distributions. In computing the common features, the computing module 418 may receive, as input, each of first sampled dataset, first data point D1, second sampled dataset, second data point D2, and a value in interval (0,1) (i.e., error margin: Epsilon); and output the exact same features among the two data points by applying the following processes: i) Common_Features=Empty Set: ii) Other_Features=Empty Set: iii) IF exists feature F1 in the first data point D1 and F2 in the second data point D2 SUCH THAT: a) Syntax(F1)==Syntax(F2)+Epsilon #Comment: F1 and F2 have similar syntax with an error margin of Epsilon, or b) Distribution(F1 with respect to D1)==Distribution(F2 with respect to D2)+Epsilon #Comment: F1 and F2 have the same data distribution within an margin of error of Epsilon: iv) DO Common_Features=Common_Features+F1: v) ELSE Other_Features=Other_Features+F1.

According to exemplary embodiment, Common_Features computed by the computing module 418 may include: Common_Features=AGE (AGEX), D—only one name is saved by the DCSCM 406 as they capture the same concept. According to exemplary embodiment, Other_Features computed by the computing module 418 may include: Other_Features=City_D1, Country_D2, CarLoan_D1, HolidayLoan_D2, Dxxxxx, D.

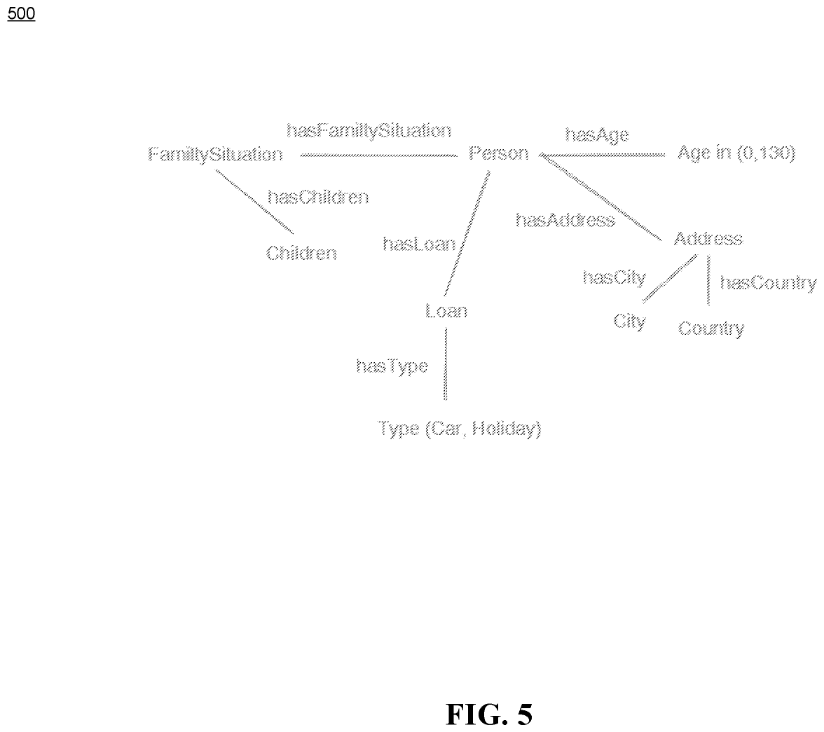

According to exemplary embodiments, the linking module 420 may be configured to link a pre-computed knowledge graph (see, e.g., FIG. 5) with the first data point D1 and the second data point D2; and the computing module 418 may be configured to compute, in response to linking, knowledge-comparable features data among the first data point D1 and the second data point D2 based on Other_Features, received as input, that are not Common_Features.

For example, FIG. 5 illustrates an exemplary knowledge graph 500 as implemented by the DCSCM 406 of FIG. 4 in accordance with an exemplary embodiment. As illustrated in FIG. 5, the exemplary knowledge graph 500 may include a tree-like data structure. For example, the trunk of the tree-like data structure may represent a person where the branches of the tree-like data structure may represent whether the person has age, family situation (i.e., has children), has address (i.e., city, country), has loan (i.e., car loan, holiday loan), etc., but the disclosure is not limited thereto.

According to exemplary embodiments, in computing the knowledge-comparable features data, the computing module 418 may implement the following processes: i) Knowledge_Comparable_Features=Empty Set: ii) IF exists feature F1_D1 and F2_D2 in Other_Features SUCH THAT: F1_D1 is subsumed by F2_D2 with respect to knowledge graph DO (Case 1): a) Create Link (F1_D1, F2_D2), b) Remove F2_D2 from Other_Features, c) Remove F1_D1 from Other_Features: iii) ELSE IF F1_D1 is subsume F2_D2 with respect to knowledge graph DO (Case 2): a) Create Link (F2_D2, F1_D1), b) Remove F2_D2 from Other_Features, c) Remove F1_D1 from Other_Features: iv) IF exists feature F1_D1 and F2_D2 in Other_Features SUCH THAT: F1_D1 and F2_D2 have similar direct root DO (Case 3): a) Create Link (F1_D1, F2_D2), b) Remove F2_D2 from Other_Features, c) Remove F1_D1 from Other_Features.

According to exemplary embodiments, Other_Features may include: Other_Features=Dxxxxx, D. The knowledge-comparable Features may include: Knowledge_Comparable_Features=Link(City_D1, Country_D2) for Case 1 and Link(CarLoan_D1, HolidayLoan_D2) for Case 3.

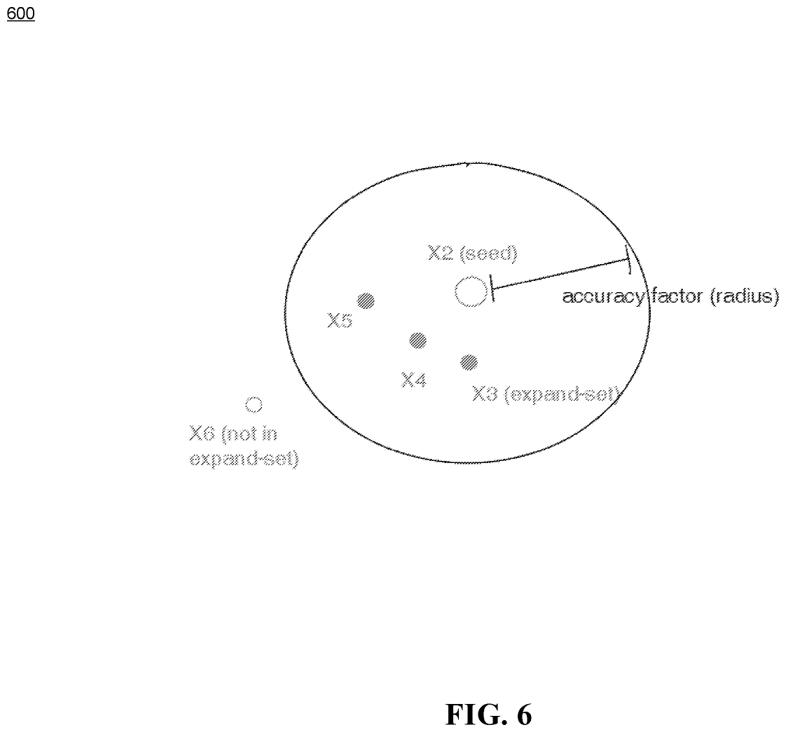

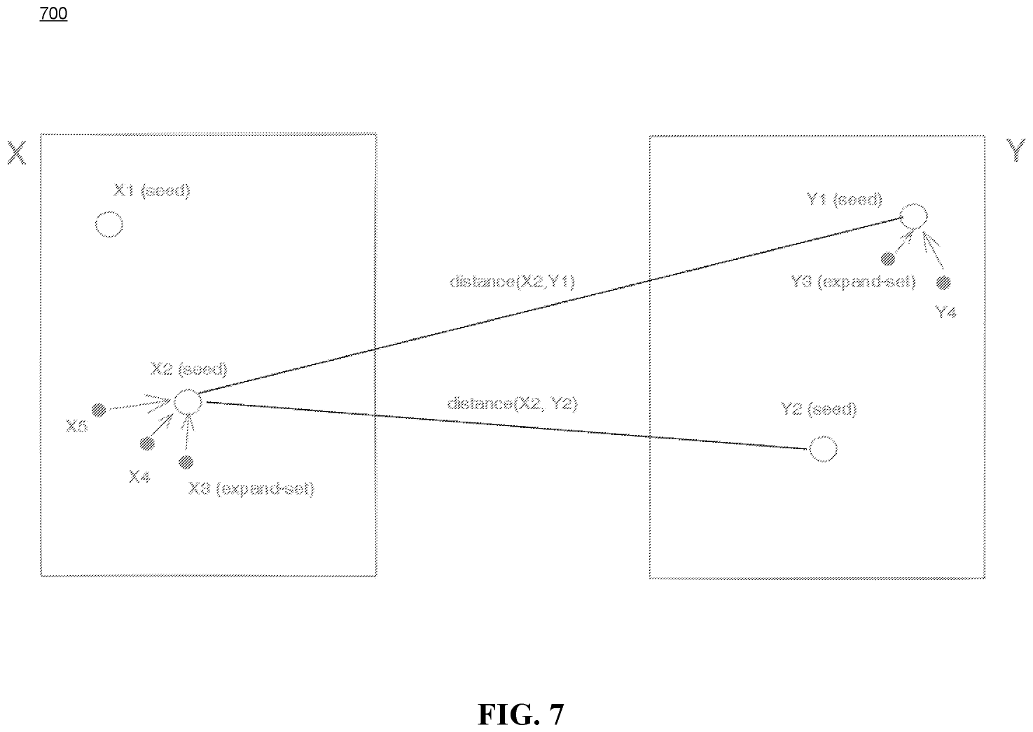

According to exemplary embodiments, the computing module 418 may be further configured to compute knowledge-comparable data based on the knowledge-comparable features data (i.e., Knowledge_Comparable_Features=Link(City_D1, Country_D2) for Case 1 and Link(CarLoan_D1, HolidayLoan_D2) for Case 3) and the common features data (i.e., Common_Features=AGE (or AGEX), D) as disclosed above. The goal is to transform input data with respect to common features and knowledge comparable features sets. The process may include: For each first data point D1, the first dataset, the second data point D2, and the second dataset DO: i) IF feature is in Common_Feature, DO Apply renaming following Common_Features dictionary: ii) IF feature is in Knowledge-Comparable Features and Case 1, Apply renaming following Knowledge-comparable Features dictionary using ONLY the more general concept/feature with respect to knowledge graph: iii) IF feature is in Knowledge-Comparable Features and Case 2, Apply renaming following Knowledge-comparable Features dictionary using ONLY Xin the left feature: LINK(X, Y) (see, e.g., FIGS. 6 and 7).

For example, in the knowledge comparable data involving X′2 (AGE=11, State=California, CarLoan=1, D=2) and Y′2 (AGE=11, State=NY, CarLoan=0, D=2), the Common_Features are X′2 (AGE=11) and Y′2 (AGE=11): Knowledge-Comparable Features are Case 1 (State-California from X′2 and State-NY from Y′2) and Case 3 (CarLoan=1 from X′2 and CarLoan=0 from Y′2) and Other_Features are D=2 from X′2 and D=2 from Y′2.

For example, in the Knowledge comparable data set involving: X1 (AGE=50, State=Texas, CarLoan=1, D=9): X2 (AGE=21, State=Texas, CarLoan=1, D=2); X3 (AGE=40, State=New York, CarLoan=1, D=−31), the Common_Features are State=Texas and CarLoan=1, Other_Features are D=9, D=2, and D=−31: Case 1 includes the states; and Case 3 includes the car loans. In the Knowledge comparable data set involving: Y1 (AGE=1, State=NY, Holiday Loan=0, Dxxxxx=93); Y2 (AGE=1, State=Nevada, HolidayLoan=0, DxXXXX=12); Y3 (AGE=10, State=Texas, HolidayLoan=0, Dxxxxx=−1), the Common_Features may be the holiday loans: case 3 may be the states and the holiday loans; and Other_Features are Dxxxxx=93, Dxxxxx=12, and Dxxxxx=−1.

According to exemplary embodiments, the computing module 418 may be configured to compute similarity of the first data point D1 and the second data point D2 based on the knowledge-comparable data as disclosed above.

For example, in computing the similarity, the computing module may receive, as input, the knowledge comparable data and the knowledge comparable data set and Other_Features as disclosed above and outputs the computation of statistical data distance aiming at computing similarity of the first data point D1 and the second data point D2 with respect to their novel representation.

For example, FIG. 6 illustrates an exemplary data seed constructions process 600 as implemented by the DCSCM 406 of FIG. 4 in accordance with an exemplary embodiment. As illustrated in FIG. 6, the data seed constructions process 600 may include the following: i) for every dataset (i.e., the first dataset and the second dataset as discussed above), an independent and identically distributed (IID) sampling algorithm is applied to construct seed points (e.g., X2, X3, X4, X5, X6): ii) for intra-dataset mapping: map an “expand-set” to a “seed point” using the radius of an accuracy factor (i.e., the circle as illustrated in FIG. 6); iii) for inter-dataset mapping: for every pair of data sets, select a unique pair of seeds in each mapping and query distance between points. As illustrated in FIG. 6, the X2 is a seed and accuracy factor is the radius of the circle where X3, X4, and X5 are included as expand-set of X2 (seed). X6 is not included in the expand-set because X6 is outside of the circle (i.e., the accuracy factor).

According to exemplary embodiments, the generating module 416 may be configured to generate a data contraction map along with assigned similarity score based on the computed similarity. FIG. 7 illustrates an exemplary dataset alignment process 700 as implemented by the DCSCM 406 of FIG. 4 in accordance with an exemplary embodiment. As illustrated in FIG. 7, the dataset alignment process 700 outputs the data contraction map by approximating pairwise distances between X and Y by an accuracy factor as discussed above with respect to FIG. 6. As illustrated in FIG. 7, a distance between X2 (seed) and Y1 (seed) is represented as distance(X2, Y1) and a distance between X2 (seed) and Y2 (seed) is represented as distance(X2, Y2). X3, X4, X5 are included in the expand-set for X2 (seed) and Y3 and Y4 are included in the expand-set for Y1(seed).

Based on the distance approximations process discussed with respect to FIG. 7, it is calculated that: i) distance(X5, Y4)<distance(X2, Y1)+accuracy factor; and ii) distance(X2, Y3)<distance(X2, Y1)+accuracy factor.

One of the output may be the transformed data points through the computation of other, common, and knowledge-comparable feature using the knowledge graph capturing domain knowledge corresponding to a line of business (as illustrated in FIG. 5). For example, the DCSCM 406 may output the data contraction map (capturing the approximation achieved) and the distance score attached to each pair. According to exemplary embodiments, the line of business may include applications for loan approval, but the disclosure is not limited thereto.

According to exemplary embodiments, in the output, the data contraction map may include: X′2 (AGE=11, State=California, CarLoan=1, D=2): Y′2 (AGE=11, State=NY, CarLoan=0, D=2): X1 (AGE=50, State=Texas, CarLoan=1, D=9): X2 (AGE=21, State=Texas, CarLoan=1, D=2): X3 (AGE=40, State=New York, CarLoan=1, D=−31); Y1 (AGE=1, State=NY, Holiday Loan=0, Dxxxxx=93); Y2 (AGE=1, State=Nevada, HolidayLoan=0, Dxxxxx=12); and Y3 (AGE=10, State=Texas, Holiday Loan=0, Dxxxxx=−1).

According to exemplary embodiments, in the output, the distance score may be attached to each pair as follows: i) distance(X5, Y4)<distance(X2, Y1)+accuracy factor+contraction; and ii) distance(X2, Y3)<distance(X2, Y1)+accuracy factor+contraction.

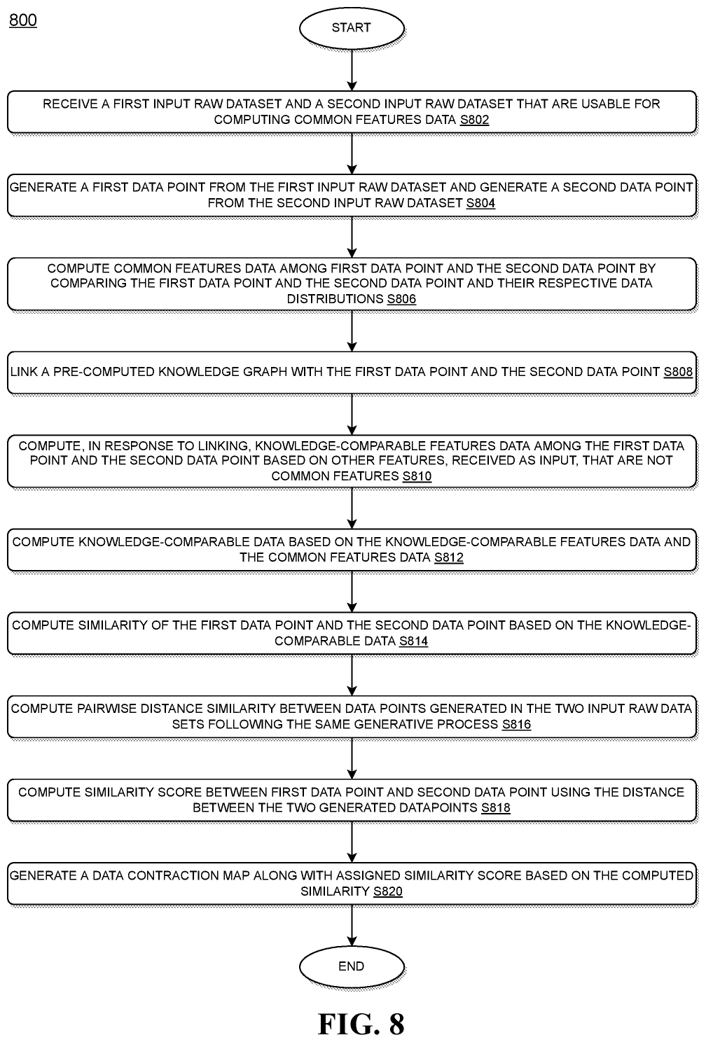

FIG. 8 illustrates an exemplary flow chart 800 implemented by the platform, language, database, and cloud agnostic DCSCM 406 of FIG. 4 for computing data contraction and estimating similarity of data points from heterogeneous data descriptors in accordance with an exemplary embodiment. It may be appreciated that the illustrated process 800 and associated steps may be performed in a different order, with illustrated steps omitted, with additional steps added, or with a combination of reordered, combined, omitted, or additional steps.

As illustrated in FIG. 8, at step S802, the process 800 may include receiving a first input raw dataset and a second input raw dataset that are usable for computing common features data.

At step S804, the process 800 may include generating a first data point from the first input raw dataset and generating a second data point from the second input raw dataset.

At step S806, the process 800 may include computing common features data among first data point and the second data point by comparing the first data point and the second data point and their respective data distributions.

At step S808, the process 800 may include linking a pre-computed knowledge graph with the first data point and the second data point.

At step S810, the process 800 may include computing, in response to linking, knowledge-comparable features data among the first data point and the second data point based on other features, received as input, that are not common features.

At step S812, the process 800 may include computing knowledge-comparable data based on the knowledge-comparable features data and the common features data.

At step S814, the process 800 may include computing similarity of the first data point and the second data point based on the knowledge-comparable data.

At step S816, the process 800 may include computing pairwise distance similarity between data points generated in the two input raw data sets following the same generative process disclosed above with respect to FIGS. 6 and 7.

At step S818, the process 800 may including computing similarity score between the first data point and the second data point using the distance between the two generated datapoints.

At step S820, the process 800 may include generating a data contraction map along with assigned similarity score based on the computed similarity.

According to exemplary embodiments, the process 800 may further include: applying a data distribution sampling algorithm onto each of said first input raw dataset and said second input raw dataset to generate a first sampled dataset and a second sampled dataset, respectively.

According to exemplary embodiments, in the process 800, a size of the first sampled dataset may be smaller than the first received input raw dataset, and wherein a size of the second sampled dataset may be smaller than the second received input raw dataset.

According to exemplary embodiments, in computing the common features, the process 800 may further include: receiving as input data the following data: the first data point generated from the first input raw dataset, the second data point generated from the second input raw dataset, the first sampled data set, and the second sampled dataset: retrieving exact same features among the first data point and the second data point; and retrieving exact same features among the first sampled data set and the second sampled dataset.

According to exemplary embodiments, in computing knowledge-comparable data, the process 800 may further include: implementing a corresponding transforming algorithm to transform corresponding received input data with respect to the common features and knowledge-comparable features sets.

According to exemplary embodiments, in the process 800, the precomputed knowledge graph is a tree-like data structure that captures domain knowledge corresponding to a line of business. According to exemplary embodiments, in the process 800, the line of business includes applications for loan approval, but the disclosure is not limited thereto.

According to exemplary embodiments, in computing the similarity of the first data point and the second data point, the process 800 may further include: applying an independent and identically distributed sampling algorithm to each of said first input raw dataset and said second input raw dataset to construct seed points: implementing an intra-dataset mapping algorithm that maps an expanded set to a seed point among the constructed seed points using a radius of an accuracy factor, wherein the accuracy factor is a parameter controlling an approximation error of a distance mapping value in an interval (0,1); implementing an inter-dataset mapping algorithm that selects, for every pair of input raw datasets, a unique pair of seeds in the distance mapping; and querying, in response to selecting, a distance between the first data point and the second data point.

According to exemplary embodiments, the DCSCD 402 may include a memory (e.g., a memory 106 as illustrated in FIG. 1) which may be a non-transitory computer readable medium that may be configured to store instructions for implementing a platform, language, database, and cloud agnostic DCSCM 406, for computing data contraction and estimating similarity of data points from heterogeneous data descriptors as disclosed herein. The DCSCD 402 may also include a medium reader (e.g., a medium reader 112 as illustrated in FIG. 1) which may be configured to read any one or more sets of instructions, e.g., software, from any of the memories described herein. The instructions, when executed by a processor embedded within the DCSCM 406, or within the DCSCD 402, may be used to perform one or more of the methods and processes as described herein. In a particular embodiment, the instructions may reside completely, or at least partially, within the memory 106, the medium reader 112, and/or the processor 104 (see FIG. 1) during execution by the DCSCD 402.

According to exemplary embodiments, the instructions, when executed, may cause the processor 104 embedded within the DCSCM 406, or the DCSCD 402 to perform the following: receiving a first input raw dataset and a second input raw dataset that are usable for computing common features data: generating a first data point from the first input raw dataset and generating a second data point from the second input raw dataset: computing common features data among first data point and the second data point by comparing the first data point and the second data point and their respective data distributions: linking a pre-computed knowledge graph with the first data point and the second data point: computing, in response to linking, knowledge-comparable features data among the first data point and the second data point based on other features, received as input, that are not common features: computing knowledge-comparable data based on the knowledge-comparable features data and the common features data: computing similarity of the first data point and the second data point based on the knowledge-comparable data; and generating a data contraction map along with assigned similarity score based on the computed similarity.

According to exemplary embodiments, the instructions, when executed, may cause the processor 104 to perform the following: applying a data distribution sampling algorithm onto each of said first input raw dataset and said second input raw dataset to generate a first sampled dataset and a second sampled dataset, respectively.

According to exemplary embodiments, in computing the common features, the instructions, when executed, may cause the processor 104 to perform the following: receiving as input data the following data: the first data point generated from the first input raw dataset, the second data point generated from the second input raw dataset, the first sampled data set, and the second sampled dataset: retrieving exact same features among the first data point and the second data point; and retrieving exact same features among the first sampled data set and the second sampled dataset.

According to exemplary embodiments, in computing knowledge-comparable data, the instructions, when executed, may cause the processor 104 to perform the following: implementing a corresponding transforming algorithm to transform corresponding received input data with respect to the common features and knowledge-comparable features sets.

According to exemplary embodiments, in computing the similarity of the first data point and the second data point, the instructions, when executed, may cause the processor 104 to perform the following: applying an independent and identically distributed sampling algorithm to each of said first input raw dataset and said second input raw dataset to construct seed points: implementing an intra-dataset mapping algorithm that maps an expanded set to a seed point among the constructed seed points using a radius of an accuracy factor, wherein the accuracy factor is a parameter controlling an approximation error of a distance mapping value in an interval (0,1): implementing an inter-dataset mapping algorithm that selects, for every pair of input raw datasets, a unique pair of seeds in the distance mapping; and querying, in response to selecting, a distance between the first data point and the second data point.

According to exemplary embodiments as disclosed above in FIGS. 1-8, technical improvements effected by the instant disclosure may include a platform for implementing a platform, language, database, and cloud agnostic data contraction and similarity computing module configured to compute data contraction and estimate similarity of data distribution from heterogeneous data descriptors, i.e., from different data distribution, or with different predictors or features or characteristics, but the disclosure is not limited thereto. According to exemplary embodiments as disclosed above in FIGS. 1-8, technical improvements effected by the instant disclosure may include a platform for implementing a platform, language, database, and cloud agnostic data contraction and similarity computing module configured to compute data contraction, and utilize the contraction as a way to evaluate data comparison and ranking, and thereby generating explanatory elements for data mapping and similarity comparison for heterogeneous data sets, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for computing data contraction and estimating similarity of data points from heterogeneous data descriptors by utilizing one or more processors along with allocated memory, the method comprising:
receiving a first input raw dataset and a second input raw dataset that are usable for computing common features data;
generating a first data point from the first input raw dataset and generating a second data point from the second input raw dataset;
computing common features data among first data point and the second data point by comparing the first data point and the second data point and their respective data distributions;
linking a pre-computed knowledge graph with the first data point and the second data point;
computing, in response to linking, knowledge-comparable features data among the first data point and the second data point based on other features, received as input, that are not common features;
computing knowledge-comparable data based on the knowledge-comparable features data and the common features data;
computing similarity of the first data point and the second data point based on the knowledge-comparable data; and
generating a data contraction map along with assigned similarity score based on the computed similarity.

2. The method according to claim 1, further comprising:
applying a data distribution sampling algorithm onto each of said first input raw dataset and said second input raw dataset to generate a first sampled dataset and a second sampled dataset, respectively.

3. The method of claim 2, wherein a size of the first sampled dataset is smaller than the first received input raw dataset, and wherein a size of the second sampled dataset is smaller than the second received input raw dataset.

4. The method according to claim 3, wherein in computing the common features, the method further comprising:
receiving as input data the following data: the first data point generated from the first input raw dataset, the second data point generated from the second input raw dataset, the first sampled data set, and the second sampled dataset;
retrieving exact same features among the first data point and the second data point; and
retrieving exact same features among the first sampled data set and the second sampled dataset.

5. The method according to claim 4, wherein in computing knowledge-comparable data, the method further comprising:
implementing a corresponding transforming algorithm to transform corresponding received input data with respect to the common features and knowledge-comparable features sets.

6. The method according to claim 1, wherein the precomputed knowledge graph is a tree-like data structure that captures domain knowledge corresponding to a line of business.

7. The method according to claim 5, wherein the line of business includes applications for loan approval.

8. The method according to claim 1, wherein in computing the similarity of the first data point and the second data point, the method further comprising:
applying an independent and identically distributed sampling algorithm to each of said first input raw dataset and said second input raw dataset to construct seed points;
implementing an intra-dataset mapping algorithm that maps an expanded set to a seed point among the constructed seed points using a radius of an accuracy factor, wherein the accuracy factor is a parameter controlling an approximation error of a distance mapping value in an interval (0,1);
implementing an inter-dataset mapping algorithm that selects, for every pair of input raw datasets, a unique pair of seeds in the distance mapping; and
querying, in response to selecting, a distance between the first data point and the second data point.

9. A system for computing data contraction and estimating similarity of data points from heterogeneous data descriptors, the method comprising:
a processor; and
a memory operatively connected to the processor via a communication interface, the memory storing computer readable instructions, when executed, causes the processor to:
receive a first input raw dataset and a second input raw dataset that are usable for computing common features data;
generate a first data point from the first input raw dataset and generate a second data point from the second input raw dataset;
compute common features data among first data point and the second data point by comparing the first data point and the second data point and their respective data distributions;
link a pre-computed knowledge graph with the first data point and the second data point;
compute, in response to linking, knowledge-comparable features data among the first data point and the second data point based on other features, received as input, that are not common features;
compute knowledge-comparable data based on the knowledge-comparable features data and the common features data;
compute similarity of the first data point and the second data point based on the knowledge-comparable data; and
generate a data contraction map along with assigned similarity score based on the computed similarity.

10. The system according to claim 9, wherein the processor is further configured to:
apply a data distribution sampling algorithm onto each of said first input raw dataset and said second input raw dataset to generate a first sampled dataset and a second sampled dataset, respectively.

11. The system of claim 10, wherein a size of the first sampled dataset is smaller than the first received input raw dataset, and wherein a size of the second sampled dataset is smaller than the second received input raw dataset.

12. The system according to claim 11, in computing the common features, the processor is further configured to:
receive as input data the following data: the first data point generated from the first input raw dataset, the second data point generated from the second input raw dataset, the first sampled data set, and the second sampled dataset;
retrieve exact same features among the first data point and the second data point; and
retrieve exact same features among the first sampled data set and the second sampled dataset.

13. The system according to claim 12, in computing knowledge-comparable data, the processor is further configured to:
implement a corresponding transforming algorithm to transform corresponding received input data with respect to the common features and knowledge-comparable features sets.

14. The system according to claim 9, wherein the precomputed knowledge graph is a tree-like data structure that captures domain knowledge corresponding to a line of business.

15. The system according to claim 13, wherein the line of business includes applications for loan approval.

16. The system according to claim 9, in computing the similarity of the first data point and the second data point, the processor is further configured to:
apply an independent and identically distributed sampling algorithm to each of said first input raw dataset and said second input raw dataset to construct seed points;
implement an intra-dataset mapping algorithm that maps an expanded set to a seed point among the constructed seed points using a radius of an accuracy factor, wherein the accuracy factor is a parameter controlling an approximation error of a distance mapping value in an interval (0,1);
implement an inter-dataset mapping algorithm that selects, for every pair of input raw datasets, a unique pair of seeds in the distance mapping; and
query, in response to selecting, a distance between the first data point and the second data point.

17. A non-transitory computer readable medium configured to store instructions for computing data contraction and estimating similarity of data points from heterogeneous data descriptors, the instructions, when executed, cause a processor to perform the following:
receiving a first input raw dataset and a second input raw dataset that are usable for computing common features data;
generating a first data point from the first input raw dataset and generating a second data point from the second input raw dataset;
computing common features data among first data point and the second data point by comparing the first data point and the second data point and their respective data distributions;
linking a pre-computed knowledge graph with the first data point and the second data point;
computing, in response to linking, knowledge-comparable features data among the first data point and the second data point based on other features, received as input, that are not common features;
computing knowledge-comparable data based on the knowledge-comparable features data and the common features data;
computing similarity of the first data point and the second data point based on the knowledge-comparable data; and
generating a data contraction map along with assigned similarity score based on the computed similarity.

18. The non-transitory computer readable medium according to claim 17, the instructions, when executed, cause the processor to further perform the following:
applying a data distribution sampling algorithm onto each of said first input raw dataset and said second input raw dataset to generate a first sampled dataset and a second sampled dataset, respectively.

19. The non-transitory computer readable medium of claim 18, wherein a size of the first sampled dataset is smaller than the first received input raw dataset, and wherein a size of the second sampled dataset is smaller than the second received input raw dataset.

20. The non-transitory computer readable medium according to claim 19, in computing the common features, the instructions, when executed, cause the processor to further perform the following:
receiving as input data the following data: the first data point generated from the first input raw dataset, the second data point generated from the second input raw dataset, the first sampled data set, and the second sampled dataset;
retrieving exact same features among the first data point and the second data point; and
retrieving exact same features among the first sampled data set and the second sampled dataset.
